(19) United States
(12) Patent Application Publication
(10) Pub. No.: US 2019/0025795 A1
(43) Pub. Date: Jan. 24, 2019

(54) METHOD FOR MONITORING A MACHINE TOOL, AND CONTROLLER

(71) Applicant: KOMET GROUP GMBH, Besigheim (DE)

(72) Inventors: Jan-Wilm BRINKHAUS, Isernhagen (DE); Joachim IMIELA, Haste (DE)

(73) Assignee: KOMET GROUP GMBH, Besigheim (DE)

(21) Appl. No.: 16/068,827

(22) PCT Filed: Jan. 4, 2017
(86) PCT No.: PCT/EP2017/050152

§ 371 Date: Jul. 9, 2018

(30) Foreign Application Priority Data
Jan. 13, 2016 (DE) DE102016100503.7

(51) Int. Cl. G05B 19/406

(52) U.S. Cl. CPC G05B 19/406; G05B 2219/31455

(57) ABSTRACT

Method for monitoring a machine tool (10), in particular a material-removing tool (10), having the steps of: (a) determining process variable measured values (B(i)) of a process variable (B) on the basis of a parameter, (b) determining whether the process variable measured values (B(i)) are in a predefined tolerance range (T(i)) which depends on the parameter, (c) if not, outputting a warning signal, and (d) constantly repeating steps (a) to (c), wherein the parameter is a control variable (i), in particular a scalar control variable (i), which always characterizes progress of the machining process. The invention provides for the control variable (i) to be calculated from the real time (t) and at least one process parameter (O, Δtₛₜᵢₗₗ) which characterizes the processing speed of the machining process.

The invention relates to a method for monitoring a machine tool, in particular a material-removing machine tool, according to the generic concept in claim 1.

According to a second aspect, the invention relates to a controller for a machine tool with (a) a process variable recording device that is configured to determine process variable measured values of a process variable that is a function of a parameter, and (b) a processing unit that comprises a digital memory.

During the material-removing process, for example when milling, the process parameters, such as the torque that acts on the cutter, change constantly. If a machining method is executed several times because several identical components are being produced, it results in a characteristic development of the machining variable over time. If the machining process is disrupted, for example because of a broken cutting tool or because a workpiece has been mounted incorrectly, the temporal development of the machining variable no longer corresponds to the expected pattern.

DE 10 2009 025 167 B3 describes a method according to the preamble of claim 1 by means of which errors in the machining procedure can be recognised on the basis of deviations from the anticipated temporal development of the machining variable.

Methods for monitoring machine tools are conducted automatically, either by the machine controller itself or by an external processing unit. The programme which forms the basis of the execution of the method must generally be adjusted to correspond to a new machine tool that is subject to monitoring, the reason being that machine tools differ in the number of axes, the tools used and the rest of their construction.

The disadvantage of known methods for monitoring machine tools is that they may tend to generate false alarms. If the criteria for an alarm are amended such that false alarms occur less frequently, actual erroneous machining processes can no longer be recognised with the same likelihood and/or an equally short delay.

DE 60 2005 003 194 T2 describes a regulator for regulating a machine tool, the regulator being configured to learn. The regulator has an acceleration determination device by means of which the position of, for example, the tool can be defined, wherein the position determined in this manner is used to control the machine tool. This is advantageous if the machine tool cannot be considered infinitely rigid, as in this case, the position of the machine tool that has been determined by the drives need not correspond to the actual position of the tool.

EP 1 455 983 B1 describes a method for capturing and analysing process data whereby measured values are captured on the basis of the control variable and a scatter range of the values is determined from several measured value sequences. This type of method may result in the problem described above, namely that mean values are calculated on the basis of measured forces recorded at different points in the machining procedure. This in turn increases either the risk of a false alarm or reduces the sensitivity of the monitoring method.

The invention aims to improve the monitoring of machine tools.

The invention solves the problem by means of a method with the features described in claim 1. The invention also solves the problem with a controller according to the preamble that is configured to execute a corresponding method.

An advantage of the solution according to the invention is that the number of false alarms can be reduced without it having an adverse effect on the likelihood and/or speed of recognising such a case. It has been proven that false alarms are often caused by a short-term suspension of the machining process by the machine controller, for instance because it took longer to generate a sufficiently high cooling lubricant pressure than the programmer anticipated, or because the programme sequence is deliberately delayed.

Known monitoring methods use real time as a parameter. If such a delay occurs, the torque acting on a cutting tool may increase at a later point, which may be interpreted as the breaking of the cutting tool. Due to that fact that, within the scope of the present invention, a parameter is used which always characterizes the progress of the machining progress, this situation cannot occur. In the event of a delay, the parameter does not continue to increase.

Within the scope of the present description, the parameter is selected specifically such that it can be described as the argument of the tool trajectory. The tool trajectory is the parameterized curve along which the tool moves. The control variable could be described as the proper time or eigentime of the machining process. In the theoretical ideal case, repetitive machining processes can be executed identically so that the real time, which is measured from a starting point in the machining process, is generally applied as a parameter. However, this brings with it the disadvantages listed above.

A process variable measured value should be understood particularly to mean a measured value that characterizes a process variable of the machining process of the machine tool. It is possible, but not necessary, that the process variable measured value is one-dimensional; it is also possible, for example, for the process variable measured value to be a vector, a matrix or an array.

The determination of process variable measured values of a process variable should be understood particularly to mean the recording of data that describe a process variable. For instance, process variable measured values are determined by the reading of related data from the machine controller. For example, the process variable is a torque that acts, for example, on a spindle which drives the tool. The tool may be a moving tool, such as a cutting tool or a drill. For example, the spindle's torque is determined on the basis of its speed and the momentary motor power.

The fact that one determines whether the process variable measured values lie within the predefined tolerance range or interval should be understood particularly to mean that a check is conducted to see whether the development of the process variable measured values lie within a tolerance band. The tolerance band is the sequence of all the tolerance ranges. In other words, the tolerance band is a planar object, whereas the tolerance range is a linear object.

The feature that a warning signal is emitted if this is not the case may be understood to mean that a warning signal is not emitted if this is the case. In other words, if the process variable measured values lie within the predefined tolerance range, as is normally the case, no signal is emitted.

The feature that the parameter always characterizes the progress of the machining process may be understood to mean that the parameter only changes when the machining process progresses.

The method comprises the step of calculating the control variable from the real time and at least one process parameter which characterizes the processing speed of the machining process. In this case, the process parameter is an input variable. In other words, the process parameter is not calculated within the scope of the method. Rather, the process parameter is captured externally. For instance, the process parameter is read from the machine controller, which may slow down, accelerate or stop the machining process based on the algorithm that forms the basis of the controller.

It is especially favourable if the at least one process parameter is a momentary overall velocity value. The overall velocity value can also be described as an override value, as the overall velocity regulator is often described as an override regulator. An overall velocity regulator can be used to directly influence the processing speed of the machining programme and, as a result, the speed of the machining process. An overall velocity value of 1 or 100% corresponds to the predefined velocity in the machining programme. The machining programme is the sequence of commands that code the machining of the workpiece. For example, this refers to an NC programme.

The overall velocity value is the value that describes the resulting processing speed in terms of the speed stipulated in the machining programme. It is possible that several partial velocity regulators exist. In this case, only their overall effect is relevant.

If the overall velocity regulator is set to 110%, for example, the tool, such as the cutter, moves 10% more quickly than at a setting of 100%. It is possible, but generally speaking not intended, for the overall velocity regulator to also influence the speed of the spindle for driving a tool. For instance, the real-time value that characterizes the position of the tool may therefore be used as a control variable if the overall velocity regulator is set to 100% and no downtimes occur.

If the overall velocity value is used to calculate the control variable, it is preferably conducted by numerically calculating the integral in terms of the momentary overall velocity value. This integral is numerically represented by calculating the sum from products, whereby one factor is the time interval and the second factor is the momentary overall velocity value within the time interval. The integral is the limit for indefinitely small time intervals. It should be noted that the control variable defined in this manner also has the dimension of seconds.

In its preferred embodiment, the at least one process parameter comprises a downtime, which characterizes a stationary point in the machining process. Many machine tool controllers are designed such that they stop the machining process if predefined threshold values are not reached, such as a cooling lubricant pressure or spindle speed, and/or if there is no axis release. This downtime is conducted in the programme independently of the override value. During the downtime, the machining process does not progress and, in accordance with this, the control variable does not change.

The step of determining whether the process variable measured values lie within the predefined tolerance range preferably comprises the following steps: (b1) for a control variable at which a process variable measured value has been determined, determining a time neighbourhood around this control variable, (b2) determining at least one reference control variable from the time nighbourhood for which at least one reference process variable measured value exists, which has been recorded in a previous, identical machining process, and (b3) calculating the tolerance range from the at least one reference process variable measured value. This procedure is based on the knowledge that, during the execution of a machining process, for example by means of a CNC programme, the process variable measured values are recorded at the same values for the control variables only in the theoretically ideal case.

Due to the fact that delays occur during every real execution of the machining process and these delays can also only be characterized by the control variable (within the scope of numerical accuracy), it may be the case that no reference process variable measured value exists for the control variable at a certain value, but that one does exist for a control variable that is close to the relevant value for the control variable. Therefore, for a predefined value of the control variable, reference control variables are sought in the time neighbourhood around this value of the control valuable, wherein a reference process variable measured value exists for the reference control variables.

Of course, the time environment must not be selected to be too large as the calculation of the tolerance range would otherwise result in too great a range. It is beneficial if the time interval is smaller than 0.5 sec.

The tolerance range is preferably calculated by way of a maximum and a minimum in terms of the reference process variable measured values B_{ref}(i_{ref}). This should be understood especially to mean that the interval limits are calculated using a formula that contains the maximum and the minimum. It is possible, but not necessary, for the formula to contain other variables, such as a measure of dispersion.

Alternatively, the tolerance range is calculated using a mean value and a measure of dispersion of at least two reference process variable measured values. The mean value may refer to the arithmetic mean, for example. Alternatively, the mean value may also be a truncated mean, a winsorized mean, a quartile mean, a Gastwirth-Cohen mean, a range mean or a similar mean value. The measure of dispersion may be the variance or the standard deviation. However, it is also possible that, for example, a trimmed variance or a trimmed standard deviation is used.

According to a preferred embodiment, the method comprises the steps of recording an end of a positioning movement and/or a start of a feed movement and the setting of the control variable to a predefined value if the end of the positioning movement and/or the start of the feed movement have been recorded. In the majority of cases, positioning movements and feed movements can be distinguished from one another within a programme, especially a CNC programme, that codes a machining process.

The aim of a positioning movement is to move the tool into a predefined position, whereby the tool is not cutting the workpiece. Positioning movements are generally conducted at the highest possible axle speed so as to keep the machining time as short as possible.

In contrast to this, a feed movement is only conducted at a speed that ensures that the tool and/or the workpiece is not overburdened. During the feed movement, the tool is engaged or moves into the workpiece at the same speed as upon engagement; this occurs either before or after engagement. Due to the fact that numerical errors may occur when calculating the control variable, it is advantageous to set the control variable to a previously determined value when an easily identifiable point in the machining process is reached. The end of a positioning movement or the start of a feed movement is well-suited to this purpose.

A cascade regulator is preferably implemented in a controller according to the invention. A cascade regulator should be understood to mean a regulator, i. e. a controller using feedback, that comprises several control circuits, wherein each superordinate regulator sets the target value for the subordinate regulator. For instance, the regulator of the highest hierarchical level may be a position regulator that controls a target position of the tool. Deviations between target and actual positions, and the time available for executing any adjustments result in a target velocity that controls a hierarchically subordinate velocity regulator.

A torque regulator may be arranged downstream of this velocity regulator, the torque regulator also controlling the target torque that is the result of the difference between the target velocity and the actual velocity. In turn, a current regulator may be arranged downstream of the torque regulator, the current regulator driving a voltage regulator. The lower the hierarchical level, the higher the frequency at which the regulator works. For example, the position regulator has a frequency of between 50 and 500 Hz, whereas the current regulator may have a frequency of between 5 and 15 kHz. The cascade regulator is preferably controlled by an NC programme that is saved in the digital memory and that codes the machining process.

In the following, the invention will be explained in more detail by way of the attached drawings. They show:

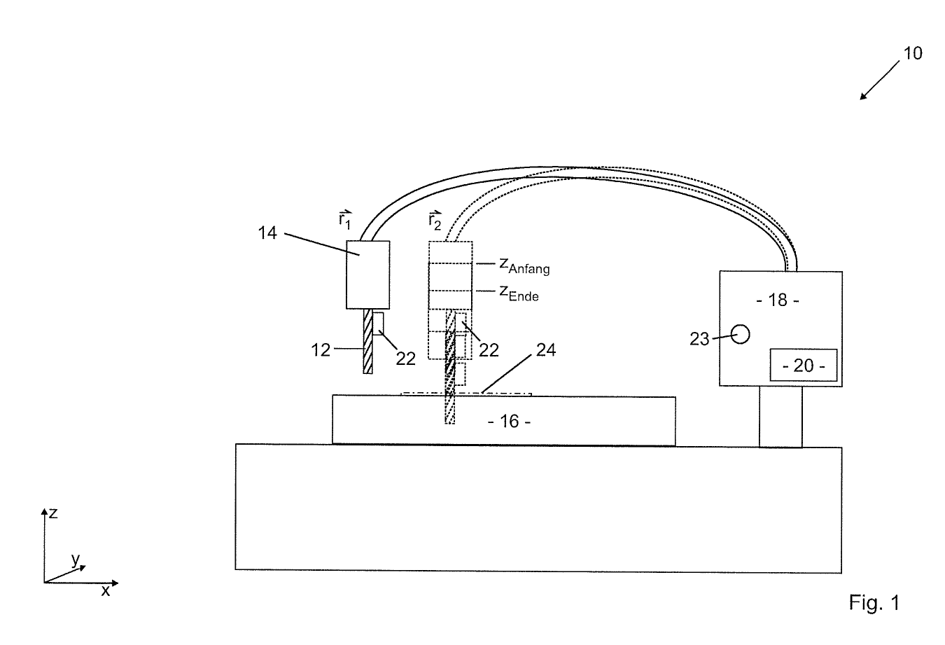

FIG. 1 a schematic view of a machine tool according to the invention for executing a method according to the invention,

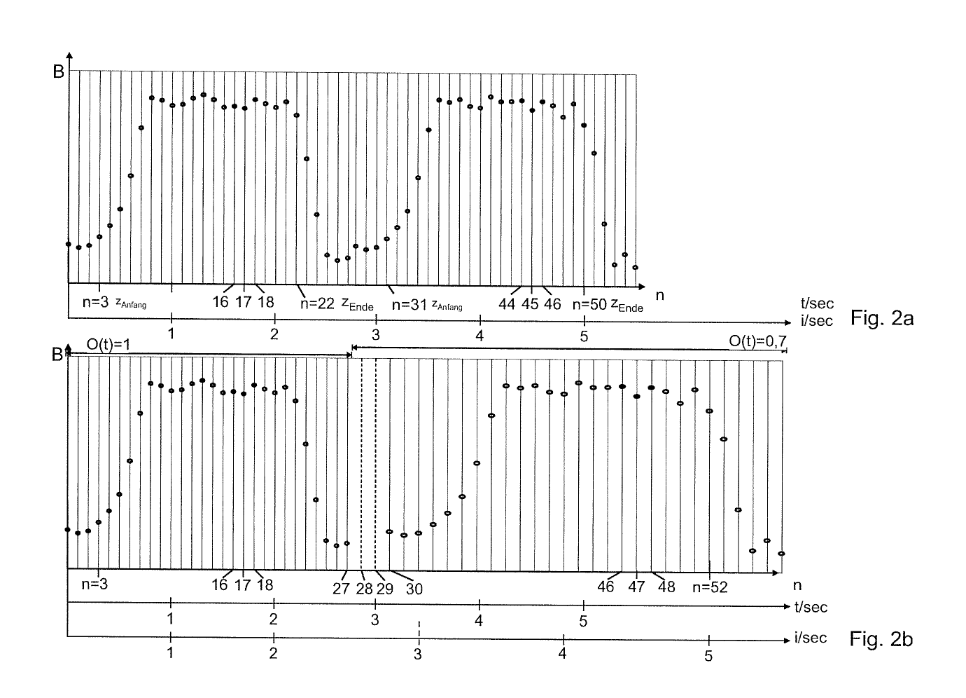

FIG. 2 a process variable development,

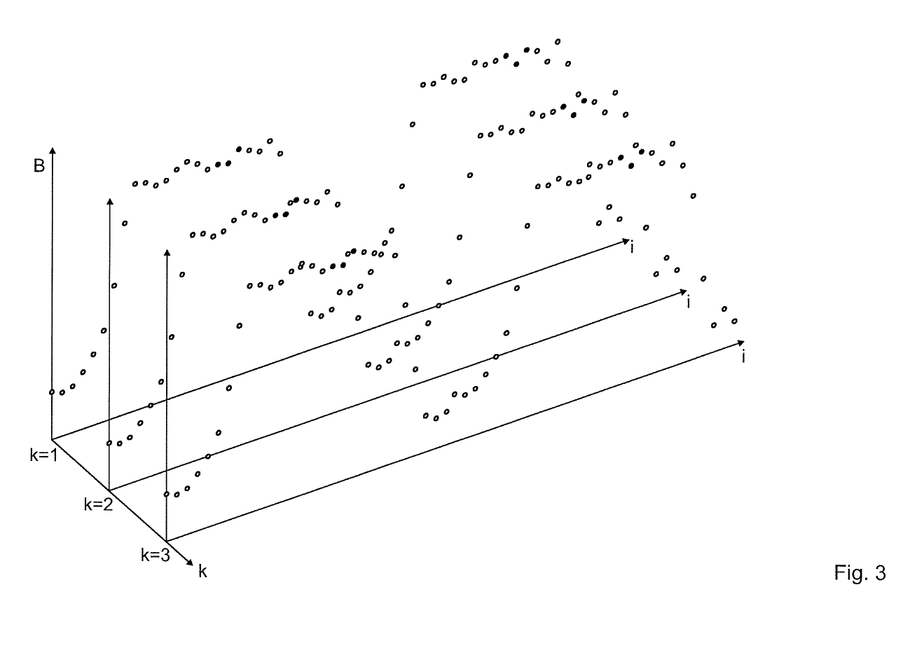

FIG. 3 a schematic view of three different process variable developments that correspond to different repetition indices,

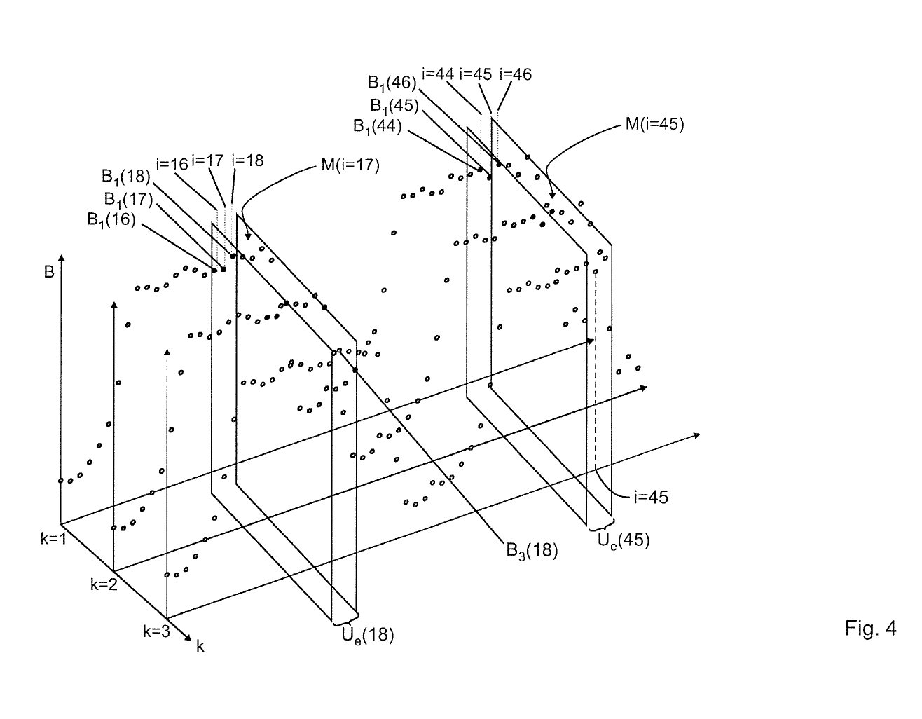

FIG. 4 a depiction of the measured value quantity and

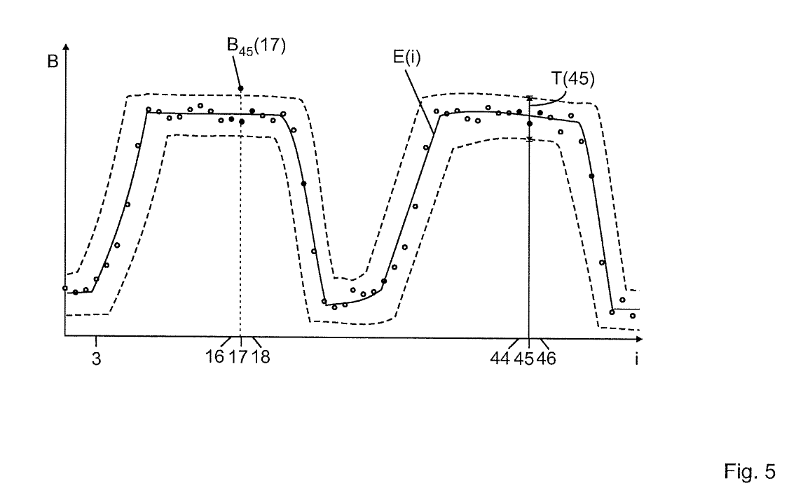

FIG. 5 the expected value development of the machining process.

FIG. 1 schematically shows a machine tool 10 with a tool 12 in the form of a drill. The tool 12 is driven by a schematically depicted spindle 14. A workpiece 16 is fixed with respect to the machine tool 10, the workpiece being processed by the tool 12 within the scope of a machining process.

The spindle 14 and therefore the tool 12 can be positioned in three spatial coordinates, namely in the x direction, the y direction and the z direction. The corresponding drives are driven by an electronic controller 18 that comprises a digital memory 20. The digital memory 20 contains a CNC programme. The digital memory 20 or a physically separate digital memory also contains a programme for conducting a method according to the invention.

The machine tool may also comprise a schematically depicted sensor 22, such as a force sensor or an acceleration sensor, which measures the acceleration of the tool 12 or the spindle 18 or another component, or a force acting on such a component.

In order to conduct a machining process, the controller 18 works through the CNC programme contained in the digital memory 20. This programme contains positions that the tool 12 is to be moved into as well as speeds for its movement. The controller 18 uses this information to calculate a trajectory [symbol] (i)=(x, y, z)(n) from a predefined starting point on the basis of a programme counter n. At the end of the programme, the controller 18 drives the tool 12 back to the starting point. Each time this type of machining process begins, the programme counter is reset, for example to the value n=0.

At the end of the machining process, the workpiece 16 is removed and replaced by a new, identical workpiece, the result of which is that the same machining process is executed again. Hereinafter, the process is considered whereby two holes are inserted into the workpiece 16. The position at which the second hole is arranged is represented by the tool next to the spindle, whereby the tool is depicted by a dashed line.

In this case, the machining process comprises the positioning of the tool 12 in the first position [symbol] =(x₁, y₁, z₁), a drilling of the hole, a retraction of the tool 12 from the workpiece 16, a positioning in the second position [symbol] =(x₂, y₂, z₂), a drilling of the second hole, a retraction of the tool 12 from the workpiece 16 and a return to the starting position.

During this machining process, a drive torque M_{A}, which the spindle 14 applies to the tool 12, is repeatedly recorded by the controller 18. Alternatively, a processing unit is available that is independent of the controller 18, this processing unit reading the drive torque M_{A} from the controller 18.

The tool 12 is driven into the workpiece 16 from each position [symbol] , [symbol] . Here, the position at which the tool 12 comes into contact with the workpiece 16 for the first time has the z coordinate z_{Anfang}; the position at which the tool 12 is inserted to the maximum depth into the workpiece 16 then has the z coordinate z_{Ende}. The positions for each bore are different because the x coordinates are different; however, except for any differences in thickness of the workpiece 15, the z coordinates are the same.

FIG. 2a schematically depicts the process variable development B₁(n)=M_{A}(n) for an ideal machining process. This process variable development plots the determined drive torque M_{A} against the programme counter n. In an ideal situation, the progress with regards to a programme counter always corresponds to the same time interval Δt. It should be recognised that when n=3 sec, the process variable M_{A} starts to increase. This is the point at which the drill 12 engages with the workpiece 16. Therefore, z=z_{Anfang} applies. In FIG. 2a, a programme counter n corresponds to a real-time time interval of 0.1 sec (sec=seconds).

At the end of the drilling process, the drill 12 is retracted from the drilled hole; the drive torque M_{A} decreases if z=z_{Ende} applies. The drill 12 is then put in a new position and another hole is drilled, wherein the drive torque M_{A} increases again from t=30 sec if z=z_{Anfang} applies.

FIG. 2b depicts the situation in which the machining process is executed in the ideal manner for the first hole. However, following the machining of the first hole, a downtime occurs Δtₛₜᵢₗₗ that lasts for two programme counters. An overall speed regulator or an override regulator 23 (see FIG. 1) is also activated after the first hole. This regulator reduces the overall speed, which may also be described as a processing speed or an execution speed, to 70% of the original speed. This may be done, for example, to reduce the wear of the tool.

Both cases result in, for example, a process variable B₁=M_{A}=at the point t=4 sec during the second cycle being considerably smaller than at the point t=4 sec during the first cycle.

Alongside the real-time t time scale, FIG. 2b depicts a scale with a control variable i, which evidently does not correspond to the imaginary unit. In an ideal scenario, the control variable i is a real number. In the present embodiment, the control variable i is calculated as

$$i ( t ) = {\int }_{{t}^{′} = {t}_{0}}^{{t}^{′} = t} O ( {t}^{′} ) {dt}^{′} - \sum Δ {t}_{still} \qquad Formula 1$$

In other words, downtimes in the machining process also cause the control variable i to stop. If the overall velocity value O is smaller than 1, the real time t is integrated in a weighted manner.

It should be added that the control variable i may of course also be calculated by setting the overall velocity value O to zero during downtimes (only) upon the calculation of the integral. Other calculation methods are possible but in these cases, downtimes do not cause an increase in the control variable i.

It should be recognised that the control variable i has the dimension of time. In an ideal, yet not realistic, situation, i.e. without downtimes and a constantly unchanged processing speed, i(t)=t+t₀ applies, wherein t₀ is the respective starting point of the machining process.

If two machining procedures are executed without disruption, the tool is in the same location relative to the workpiece for every value of the control variable i, except for numerical errors, even if downtimes or a change in the processing speed occur. Formula 1 is numerically represented by a sum.

FIG. 3 shows three developments of process variable measured values, namely B₁(i), B₂(i) and B₃(i), wherein the subscript index is the repetition index k. Each time the tool 12 processes a new workpiece 16, the repetition index k is increased by one. This results in the generation of a consecutively numbered set of process variable developments Bₖ(i)=Mₖ(i). The current machining process is the one with the repetition index k=3.

FIG. 4 depicts two developments of process variable measured values for k=1 and k=2. The machining process with the repetition index k=3 is almost complete, the most recently recorded process variable measured value is (B(45)) for the control variable i=45.

In order to determine whether the process variable measured values (B(i=45)) lie within a predefined tolerance range T(i=45)), a time environment Uₑ(45) is first of all determined, wherein the variable e of the environment is selected in such a way that, for instance, the tool has covered a predefined path during the period of time described by the environment, wherein this path preferably has a value of at least 500 μm and at most 5000 μm. In the example, e=i, such that all process variable measured values Bₖ(44), Bₖ(45) and Bₖ(46) for k=1 and k=2 lie within U₁(45). The fact that all i in the present example are whole numbers is for the sake of simplification; in reality, the i need not be integers.

The reference process variable measured values B₁(44), B₁(45) B₁(46), B₂(44), B₂(45) and B₂(46) are used to calculate the expected value E(45) as the mean value and the varianceσ²(45) as the measure of dispersion, from which the tolerance range T(45)={E(45)−σ²(45); E(45)+σ²(45)} is calculated. This calculation is conducted for all i of the current machining process. FIG. 4 also shows the calculation for i=18.

It is possible, but not necessary, that not all Bₖ(i) that lie within the time environment Uₑ(i) are used for the calculation of the tolerance range. In the event of a large number of repetitions, it may be practical for the repetition quantity to comprise, for example, the last twenty repetition indices in order to keep the calculation small.

FIG. 5 depicts the expected value development E(i) following a number of sound machining processes, i.e. machining processes that were conducted free of errors. FIG. 5 also provides a purely schematic representation of the tolerance range T(45). The area between the dashed curves is the tolerance band.

### REFERENCE LIST

10 machine tool

12 tool

14 spindle

16 workpiece

18 controller

20 digital memory

22 sensor

24 variations in allowances

\vec{r}(i) trajectory

i control variable

M_{A} drive torque

k repetition index

n programme counter (natural number)

T tolerance range

t real time

U environment

O overall velocity value

1. A method for monitoring a machine tool, comprising:
(a) determining process variable measured values of a process variable on the basis of a parameter,
(b) determining whether the process variable measured values lie within a predefined tolerance range which depends on the parameter,
(c) if not, outputting a warning signal and
(d) constantly repeating steps (a) to (c),
(e) wherein the parameter is a control variable which always characterizes progress of the machining process, and
(f) calculating the control variable from a time and at least one process parameter which characterizes a processing speed of the machining process.

2. The method according to claim 1, wherein the at least one process parameter is a momentary velocity value of an overall velocity regulator.

3. The method according to claim 2, wherein the calculation of the control variable comprises the calculation of an integral over the momentary overall velocity value.

4. The method according to claim 1 wherein the at least one process parameter comprises a downtime that characterizes a stationary point in the machining process.

5. The method according to claim 1 wherein step (b) includes the following steps:
(b1) for a control variable at which a process variable measured value has been determined, determining a time neighbourhood around this control variable,
(b2) determining at least one reference control variable from the time neighbourhood for which at least one reference process variable measured value exists which has been recorded in a previous, identical machining process, and
(b3) calculating a tolerance range using the at least one reference process variable measured value.

6. The method according to claim 5 wherein the tolerance range is calculated using a maximum and a minimum above the reference process variable measured values.

7. The method according to claim 1 further comprising:
(a) recording an end of a positioning movement and/or a start of a feed movement, and
(b) setting the control variable (i) to a predefined value.

8. A controller for a material-removing machine tool, comprising:
(a) a process variable recording device configured to determine process variable measured values of a process variable based on a parameter, and
(b) a processing unit which comprises a digital memory (20), wherein the digital memory is non-transient and is encoded with instructions for monitoring the machine tool according to the method of claim 1.

9. The controller according to claim 8, further comprising a cascade regulator that is controlled using the instructions encoded in the digital memory.

10. A machine tool with a controller according to claim 8.

11. The method of claim 1 wherein the machine tool is a material-removing machine tool, and wherein the control variable is a scalar control variable.
